(19) United States
(12) Patent Application Publication
(10) Pub. No.: US 2026/0058370 A1
(43) Pub. Date: Feb. 26, 2026

(54) ANTENNA STRUCTURE

(71) Applicant: WNC Corporation, Hsinchu (TW)

(72) Inventors: Cheng-Rui ZHANG, Hsinchu (TW); Chun-Kai CHEN, Hsinchu (TW); Jian-Zhong CHEN, Hsinchu (TW); Hong-Jun JIAN, Hsinchu (TW)

(21) Appl. No.: 19/261,259

(22) Filed: Jul. 7, 2025

(30) Foreign Application Priority Data
Aug. 21, 2024 (TW) 113131384

(51) Int. Cl. H01Q 9/04; H01Q 1/48; H01Q 5/20

(52) U.S. Cl. CPC H01Q 9/0421; H01Q 1/48; H01Q 5/20; H01Q 9/0414

(57) ABSTRACT

An antenna structure includes a ground element, a feeding radiation element, a connection radiation element, a grounding radiation element, a shorting radiation element, a first radiation element, a second radiation element, a third radiation element, a fourth radiation element, and a nonconductive support element. The feeding radiation element has a positive feeding point. The first radiation element and the second radiation element are coupled to the feeding radiation element. The second radiation element is at least partially surrounded by the first radiation element. The grounding radiation element has a negative feeding point. The grounding radiation element is coupled through the connection radiation element to the feeding radiation element. The shorting radiation element is coupled to the ground element. The third radiation element and the fourth radiation element are coupled to the shorting radiation element. The fourth radiation element is at least partially surrounded by the third radiation element.

### CROSS-REFERENCE TO RELATED PATENT APPLICATION

This application claims the benefit of priority to Taiwan Patent Application No. 113131384, filed on Aug. 21, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an antenna structure, particularly to a wideband antenna structure.

### BACKGROUND OF THE DISCLOSURE

With the advancement of mobile communication technologies, mobile devices have become increasingly prevalent in recent years. Common examples include laptops, mobile phones, multimedia players, and other multifunctional portable electronic devices. To meet consumer demands, mobile devices typically feature wireless communication capabilities. Some cover long-range wireless communications, such as mobile phones using 2G, 3G, and LTE (Long Term Evolution) systems and their respective frequency bands of 700 MHz, 850 MHZ, 900 MHz, 1800 MHZ, 1900 MHZ, 2100 MHz, 2300 MHz, and 2500 MHz used for communications. Others cover short-range wireless communications, such as Wi-Fi and Bluetooth systems using frequency bands of 2.4 GHz, 5.2 GHz, and 5.8 GHz for communications.

Antennas are indispensable components in the field of wireless communications. If the bandwidth of an antenna used for receiving or transmitting signals is insufficient, it may easily cause a decline in the communication quality of mobile devices. Therefore, designing small-sized, wideband antenna components is a significant issue for antenna designers.

### SUMMARY OF THE DISCLOSURE

In an exemplary embodiment, the present disclosure provides an antenna structure that includes a ground element, a feeding radiation element, a first radiation element, a second radiation element, a connection radiation element, a grounding radiation element, a shorting radiation element, a third radiation element, a fourth radiation element, and a nonconductive support element. The feeding radiation element has a positive feeding point. The first radiation element and the second radiation element are coupled to the feeding radiation element. The second radiation element is at least partially surrounded by the first radiation element. The grounding radiation element has a negative feeding point and is coupled to the ground element, and the grounding radiation element is further coupled to the feeding radiation element through the connection radiation element. The shorting radiation element is coupled to the ground element. The third radiation element and the fourth radiation element are coupled to the shorting radiation element. The fourth radiation element is at least partially surrounded by the third radiation element. The ground element, the feeding radiation element, the connection radiation element, the grounding radiation element, the shorting radiation element, the first radiation element, the second radiation element, the third radiation element, and the fourth radiation element are distributed on the nonconductive support element.

In some embodiments, the antenna structure further includes a fifth radiation element and a sixth radiation element. The fifth radiation element is coupled to the ground element and is in proximity to the first radiation element. The sixth radiation element is coupled to the ground element.

In some embodiments, the nonconductive support element has a first portion and a second portion, and an angle is formed between the second portion and the first portion.

In some embodiments, the ground element, the connection radiation element, the grounding radiation element, and the sixth radiation element are disposed on the first portion of the nonconductive support element.

In some embodiments, the first radiation element, the second radiation element, the third radiation element, and the fourth radiation element are disposed on the second portion of the nonconductive support element.

In some embodiments, the feeding radiation element, the shorting radiation element, and the fifth radiation element extend from the first portion to the second portion of the nonconductive support element.

In some embodiments, a length of each of the first portion and the second portion of the nonconductive support element is greater than or equal to 3 mm.

In some embodiments, the grounding radiation element is coupled to a first grounding point on the ground element and includes a narrower portion and a wider portion, the connection radiation element is coupled to the narrower portion, and the negative feeding point is positioned on either the narrower portion or the wider portion.

In some embodiments, there is a first distance between the feeding radiation element and the narrower portion of the grounding radiation element, and there is a second distance between the feeding radiation element and the wider portion of the grounding radiation element, with the first distance being at least twice the second distance.

In some embodiments, the shorting radiation element includes a main portion and an additional portion, the fourth radiation element being coupled to a second grounding point on the ground element through the main portion, and the third radiation element is coupled to the additional portion.

In some embodiments, a first coupling gap is formed between the second radiation element and the first radiation element, a second coupling gap is formed between the fourth radiation element and the third radiation element, and a width of each of the first coupling gap and the second coupling gap is less than or equal to 3 mm.

In some embodiments, the first radiation element further includes a terminal bending portion, a third coupling gap is formed between the fifth radiation element and the terminal bending portion, and a width of the third coupling gap is less than or equal to 3 mm.

In some embodiments, the antenna structure covers a first frequency band, a second frequency band, and a third frequency band, the first frequency band is from 2400 MHz to 2500 MHz, the second frequency band is from 5150 MHz to 5850 MHz, and the third frequency band is from 5925 MHz to 7125 MHz.

In some embodiments, the total length of the feeding radiation element, the connection radiation element, and the grounding radiation element is substantially equal to 0.25 wavelength of a central frequency of the first frequency band.

In some embodiments, the length of the first radiation element is substantially equal to 0.25 wavelength of the highest frequency of the first frequency band.

In some embodiments, the total length of the feeding radiation element and the second radiation element is from 0.16 to 0.25 wavelength of the lowest frequency of the first frequency band.

In some embodiments, the total length of the shorting radiation element and the third radiation element is from 0.125 to 0.25 wavelength of a central frequency of the second frequency band.

In some embodiments, the total length of the main portion of the shorting radiation element and the fourth radiation element is from 0.125 to 0.25 wavelength of a central frequency of the third frequency band.

In some embodiments, the length of the fifth radiation element is from 0.0625 to 0.25 the wavelength of a central frequency of the first frequency band.

In some embodiments, the length of the sixth radiation element is from 1 mm to 5 mm.

These and other aspects of the present disclosure will become apparent from the following description of the embodiment taken in conjunction with the corresponding drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 shows a perspective view of the antenna structure according to an embodiment of the present disclosure.

FIG. 2 shows a return loss graph of the antenna structure applied to a convertible notebook computer in notebook mode according to an embodiment of the present disclosure.

FIG. 3 shows a return loss graph of the antenna structure applied to a convertible notebook computer in tablet mode according to an embodiment of the present disclosure.

FIG. 4 shows a perspective view of the antenna structure according to another embodiment of the present disclosure.

### DETAILED DESCRIPTION OF THE EXEMPLARY EMBODIMENTS

To make the objectives, features, and advantages of the present disclosure clearer and more understandable, specific embodiments of the present disclosure are provided below, along with detailed descriptions in conjunction with the accompanying drawings.

Certain terms are used in the specification and the claims to refer to specific components. Those skilled in the art will understand that different hardware manufacturers may use different terms to refer to the same component. The specification and claims do not distinguish components based on their names but based on the differences in their functions. The terms “comprising” and “including” as used in the specification and claims are open-ended terms and should be interpreted as “including but not limited to.” The term “substantially” refers to acceptable variations where those skilled in the art can solve technical problems within a certain variation range to achieve the basic technical effect. Moreover, the term “coupled” in this specification includes any direct or indirect electrical connection means. Therefore, if the content describes a first device being coupled to a second device, it means that the first device can be directly electrically connected to the second device, or indirectly electrically connected to the second device through other devices or connection means.

The following disclosure provides many different embodiments or examples to implement different features of the present disclosure. Specific examples of various components and their arrangements are described in the following disclosure to simplify the explanation. Of course, these specific examples are not meant to be used as limitations. For example, if the disclosure describes a first feature formed on or above a second feature, it may include embodiments where the first feature and the second feature are directly in contact, or it may include embodiments where additional features are formed between the first feature and the second feature, such that the first feature and the second feature can possibly not be directly in contact. Additionally, different examples in the disclosure may reuse the same reference numerals and/or labels. These repetitions are for simplification and clarity purposes and are not meant to limit the specific relationships between the different embodiments and/or structures discussed.

Furthermore, spatial related terms, such as “beneath,” “below,” “lower,” “above,” “upper” and similar terms, are used to describe the relationship between one element or feature to another element(s) or feature(s) as illustrated in the figures. In addition to the orientations depicted in the figures, these spatial related terms are intended to encompass different orientations of the device in use or in operation. The device may be oriented in different ways (rotated 90 degrees or other orientations), and the spatial related terms used herein can be interpreted accordingly.

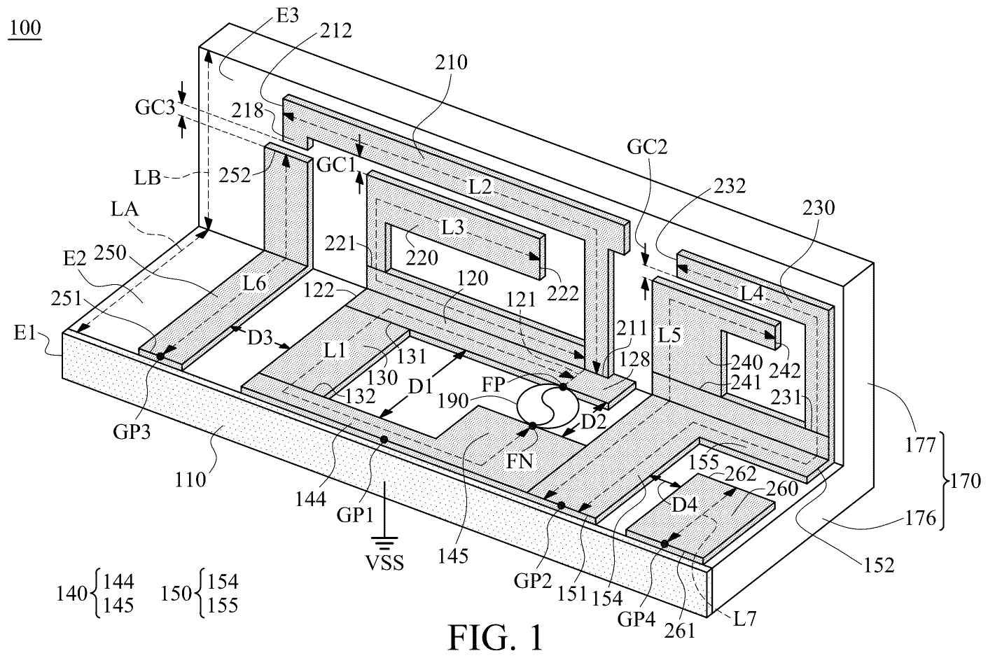

FIG. 1 shows a perspective view of the antenna structure 100 according to an embodiment of the present disclosure. The antenna structure 100 can be applied to a mobile device, such as a notebook computer. As shown in FIG. 1, the antenna structure 100 includes a ground element 110, a feeding radiation element 120, a connection radiation element 130, a grounding radiation element 140, a shorting radiation element 150, a nonconductive support element 170, a first radiation element 210, a second radiation element 220, a third radiation element 230, a fourth radiation element 240, a fifth radiation element 250, and a sixth radiation element 260. The ground element 110, feeding radiation element 120, connection radiation element 130, grounding radiation element 140, shorting radiation element 150, first radiation element 210, second radiation element 220, third radiation element 230, fourth radiation element 240, fifth radiation element 250, and sixth radiation element 260 can all be made of metal materials, such as copper, silver, aluminum, iron, or their alloys.

The nonconductive support element 170 can be made of plastic material, wherein the ground element 110, feeding radiation element 120, connection radiation element 130, grounding radiation element 140, shorting radiation element 150, first radiation element 210, second radiation element 220, third radiation element 230, fourth radiation element 240, fifth radiation element 250, and sixth radiation element 260 are distributed on the nonconductive support element 170. In some embodiments, the nonconductive support element 170 includes a first portion 176 and a second portion 177, wherein the second portion 177 can be substantially perpendicular to the first portion 176. For example, the first portion 176 of the nonconductive support element 170 may have a first surface E1 and a second surface E2 that are perpendicular to each other, while the second portion 177 of the nonconductive support element 170 may have a third surface E3 that is perpendicular to the second surface E2, wherein the second surface E2 can be connected between the first surface E1 and the third surface E3. However, the present disclosure is not limited thereto. In other embodiments, an angle exists between the first portion 176 and the second portion 177 of the nonconductive support element 170, where such angle can be from 60 degrees to 120 degrees, and may not necessarily be exactly 90 degrees.

Specifically, the ground element 110 can be disposed on the first surface E1 of the first portion 176 of the nonconductive support element 170, while the connection radiation element 130, grounding radiation element 140, and the sixth radiation element 260 can all be disposed on the second surface E2 of the first portion 176 of the nonconductive support element 170. The first radiation element 210, second radiation element 220, third radiation element 230, and fourth radiation element 240 can all be disposed on the third surface E3 of the second portion 177 of the nonconductive support element 170. Alternatively, the first radiation element 210, second radiation element 220, third radiation element 230, and fourth radiation element 240 can extend to the second surface E2 of the first portion 176 of the nonconductive support element 170. Additionally, the feeding radiation element 120, shorting radiation element 150, and fifth radiation element 250 can all extend from the first portion 176 to the second portion 177 of the nonconductive support element 170 (or extend from the second surface E2 to the third surface E3). It should be understood that the distribution of the radiation elements on the nonconductive support element 170 can be further adjusted according to different requirements.

The ground element 110 can be implemented using a ground copper foil. In some embodiments, the ground element 110 can be coupled to a ground voltage VSS, which can be provided by a system ground plane of the antenna structure 100 (not shown).

The feeding radiation element 120 has a first end 121 and a second end 122, with a positive feeding point FP located at the first end 121 of the feeding radiation element 120. The positive feeding point FP can be further coupled to a positive electrode of a signal source 190. For example, the signal source 190 can be a radio frequency (RF) module used to excite the antenna structure 100. In some embodiments, the feeding radiation element 120 can be substantially straight, but is not limited thereto. In some embodiments, the feeding radiation element 120 further includes a terminal extension segment 128 located at the first end 121, where such terminal extension segment 128 can be rectangular and disposed only on the second surface E2 of the first portion 176 of the nonconductive support element 170. Alternatively, the terminal extension segment 128 can also extend onto the third surface E3 of the second portion 177 of the nonconductive support element 170.

The connection radiation element 130 has a first end 131 and a second end 132, wherein the first end 131 of the connection radiation element 130 is coupled to the second end 122 of the feeding radiation element 120. In some embodiments, the connection radiation element 130 can be substantially planar and straight, and it can be substantially perpendicular to the feeding radiation element 120, but is not limited thereto.

The grounding radiation element 140 is coupled to a first grounding point GP1 on the ground element 110. Specifically, the grounding radiation element 140 includes a narrower portion 144 and a wider portion 145, wherein the second end 132 of the connection radiation element 130 is coupled to the narrower portion 144, and a negative feeding point FN is located on the wider portion 145. That is, the grounding radiation element 140 can be coupled to the feeding radiation element 120 through the connection radiation element 130. Additionally, the negative feeding point FN can also be coupled to a negative electrode of the signal source 190.

The shorting radiation element 150 has a first end 151 and a second end 152, wherein the first end 151 of the shorting radiation element 150 is coupled to a second grounding point GP2 on the ground element 110. Specifically, the shorting radiation element 150 includes a main portion 154 in proximity to the first end 151 and an additional portion 155 in proximity to the second end 152, wherein the additional portion 155 can be substantially perpendicular to the main portion 154. It should be noted that the terms “in proximity to” or “adjacent to” recited in this specification can indicate that the spacing between two corresponding elements is less than a predetermined distance (e.g., 10 mm or shorter), and can also include the case where the two corresponding elements are in direct contact with each other (i.e., the aforementioned spacing is reduced to 0).

The first radiation element 210 has a first end 211 and a second end 212, wherein the first end 211 of the first radiation element 210 is coupled to the first end 121 (or/and the terminal extension segment 128) of the feeding radiation element 120, and the second end 212 of the first radiation element 210 is an open end. In some embodiments, the first radiation element 210 can be substantially L-shape, but is not limited thereto. In some embodiments, the first radiation element 210 further includes a terminal bending segment 218 located at the second end 212.

The second radiation element 220 has a first end 221 and a second end 222, wherein the first end 221 of the second radiation element 220 is coupled to the second end 122 of the feeding radiation element 120, and the second end 222 of the second radiation element 220 is an open end. For example, the second end 222 of the second radiation element 220 and the second end 212 of the first radiation element 210 can extend in directions that are substantially opposite and pointing away from each other. Additionally, the second radiation element 220 is at least partially surrounded by the first radiation element 210, wherein a first coupling gap GC1 is formed between the second radiation element 220 and the first radiation element 210. In some embodiments, the second radiation element 220 can be substantially inverted L-shape, but is not limited thereto.

The third radiation element 230 has a first end 231 and a second end 232, wherein the first end 231 of the third radiation element 230 is coupled to the additional portion 155 of the shorting radiation element 150, and the second end 232 of the third radiation element 230 is an open end. In some embodiments, the third radiation element 230 can be substantially another L-shape, but is not limited thereto.

The fourth radiation element 240 has a first end 241 and a second end 242, wherein the first end 241 of the fourth radiation element 240 is coupled to the second grounding point GP2 through the main portion 154 of the shorting radiation element 150, and the second end 242 of the fourth radiation element 240 is an open end. For example, the second end 242 of the fourth radiation element 240 and the second end 232 of the third radiation element 230 can extend in directions substantially opposite and pointing away from each other. Additionally, the fourth radiation element 240 is at least partially surrounded by the third radiation element 230, with a second coupling gap GC2 formed between the fourth radiation element 240 and the third radiation element 230. In some embodiments, the fourth radiation element 240 can be substantially another inverted L-shape, but is not limited thereto.

The fifth radiation element 250 has a first end 251 and a second end 252, wherein the first end 251 of the fifth radiation element 250 is coupled to a third grounding point GP3 on the ground element 110, and the second end 252 of the fifth radiation element 250 is an open end and can be in proximity to the second end 212 of the first radiation element 210. For example, the third grounding point GP3 can be different from the aforementioned first grounding point GP1 and second grounding point GP2. In some embodiments, the fifth radiation element 250 can be substantially another straight shape, but is not limited thereto. In some embodiments, a third coupling gap GC3 can be formed between the fifth radiation element 250 and the terminal bending segment 218.

The sixth radiation element 260 has a first end 261 and a second end 262, wherein the first end 261 of the sixth radiation element 260 is coupled to a fourth grounding point GP4 on the ground element 110, and the second end 262 of the sixth radiation element 260 is an open end. For example, the fourth grounding point GP4 can be different from the aforementioned first grounding point GP1, second grounding point GP2, and third grounding point GP3. In some embodiments, the sixth radiation element 260 can be substantially another straight shape, but is not limited thereto. In some embodiments, the sixth radiation element 260 can also be at least partially surrounded by the shorting radiation element 150. It should be understood that in other embodiments, the fifth radiation element 250 and the sixth radiation element 260 can also be removed from the antenna structure 100.

In some embodiments, the antenna structure 100 is applied to a convertible notebook computer, where such convertible notebook computer can operate in a notebook mode or a tablet mode.

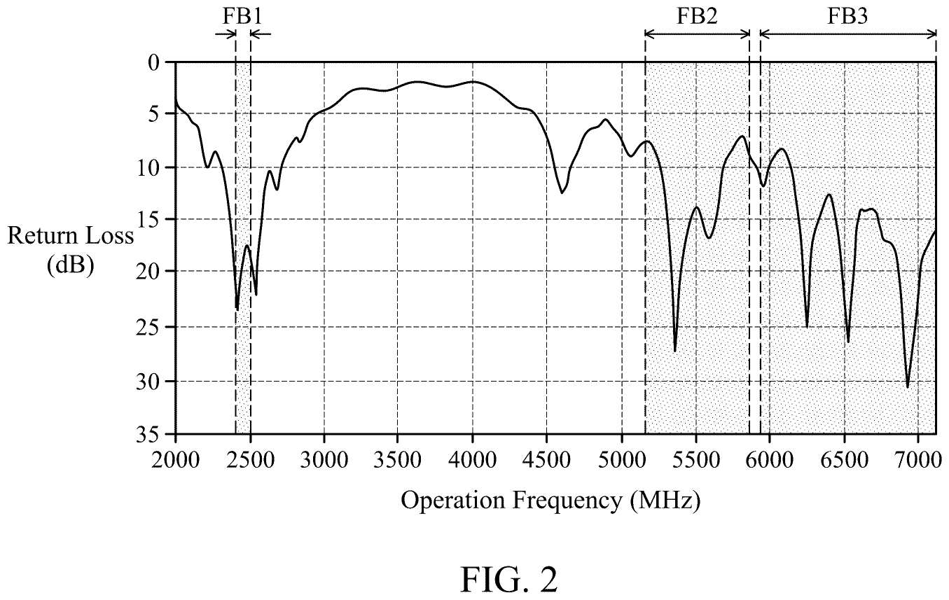

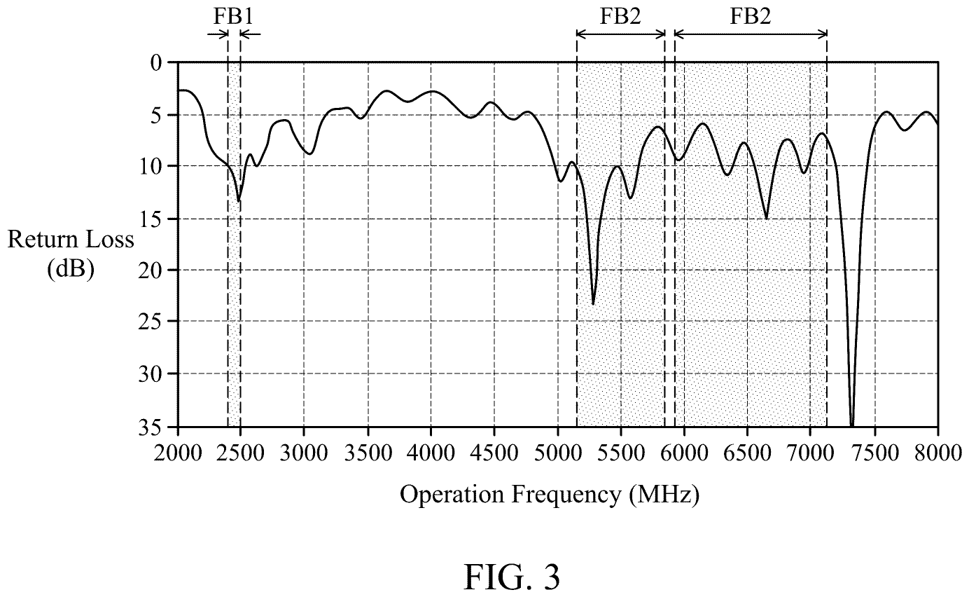

FIG. 2 shows a return loss graph of the antenna structure 100 being applied to a convertible notebook computer in notebook mode according to an embodiment of the present disclosure. FIG. 3 shows a return loss graph of the antenna structure 100 being applied to a convertible notebook computer in tablet mode according to an embodiment of the present disclosure. According to the measurement results in FIGS. 2 and 3, the antenna structure 100 can cover a first frequency band FB1, a second frequency band FB2, and a third frequency band FB3. For example, the first frequency band FB1 can be from 2400 MHz to 2500 MHz, the second frequency band FB2 can be from 5150 MHz to 5850 MHz, and the third frequency band FB3 can be from 5925 MHz to 7125 MHz. Therefore, whether in notebook mode or tablet mode, the antenna structure 100 can support wideband operation for traditional WLAN (Wireless Local Area Network) and the new generation Wi-Fi 6E and Wi-Fi 7.

In some embodiments, the operating principle of the antenna structure 100 can be described as follows. The feeding radiation element 120, connection radiation element 130, and grounding radiation element 140 can be excited to generate the aforementioned first frequency band FB1. Furthermore, the feeding radiation element 120, first radiation element 210, and second radiation element 220 can also be excited to generate the aforementioned first frequency band FB1. The shorting radiation element 150 and third radiation element 230 can be excited to generate the aforementioned second frequency band FB2. The shorting radiation element 150 and fourth radiation element 240 can be excited to generate the aforementioned third frequency band FB3. The fifth radiation element 250 can be used to fine-tune the impedance matching of the aforementioned first frequency band FB1 and second frequency band FB2. Additionally, the sixth radiation element 260 can be used to fine-tune the impedance matching of the aforementioned third frequency band FB3. According to actual measurement results, when the convertible notebook computer is operating in notebook mode, some radiation elements located on the second surface E2 of the first portion 176 of the nonconductive support element 170 (e.g., the connection radiation element 130, grounding radiation element 140, and the sixth radiation element 260, but is not limited thereto) will contribute to the main radiation pattern of the antenna structure 100. Conversely, when the convertible notebook computer operates in tablet mode, some other radiation elements located on the third surface E3 of the second portion 177 of the nonconductive support element 170 (e.g., the first radiation element 210, second radiation element 220, third radiation element 230, and fourth radiation element 240, but is not limited thereto) will contribute to the main radiation pattern of the antenna structure 100. In other words, even if the convertible notebook computer frequently switches between different operating modes, its antenna structure 100 can still maintain relatively good communication quality.

In some embodiments, the component dimensions of the antenna structure 100 can be described as follows. In the nonconductive support element 170, the length LA of the first portion 176 can be greater than or equal to 3 mm (e.g., approximately 10 mm), and the length LB of the second portion 177 can also be greater than or equal to 3 mm (e.g., approximately 10 mm), wherein the ratio of the length LA to the length LB (LA/LB) can be from ⅓ to 3 (e.g., approximately 1). The total length L1 of the feeding radiation element 120, connection radiation element 130, and grounding radiation element 140 can be substantially equal to 0.25 wavelength (λ/4) of the central frequency (e.g., 2450 MHz) of the first frequency band FB1 of the antenna structure 100. The length L2 of the first radiation element 210 can be substantially equal to 0.25 wavelength (λ/4) of the highest frequency (e.g., 2500 MHz) of the first frequency band FB1 of the antenna structure 100. The total length L3 of the feeding radiation element 120 and second radiation element 220 can be from 0.16 to 0.25 wavelength (4Δ/25˜λ/4) of the lowest frequency (e.g., 2400 MHZ) of the first frequency band FB1 of the antenna structure 100. The total length L4 of the shorting radiation element 150 and third radiation element 230 can be from 0.125 to 0.25 wavelength (λ/8˜Δ/4) of the central frequency of the second frequency band FB2 of the antenna structure 100. The total length L5 of the main portion 154 of the shorting radiation element 150 and fourth radiation element 240 can be from 0.125 to 0.25 wavelength (λ/8˜λ/4) of the central frequency of the third frequency band FB3 of the antenna structure 100. The length L6 of the fifth radiation element 250 can be from 0.0625 to 0.25 wavelength (λ/16˜λ/4) of the central frequency of the first frequency band FB1 of the antenna structure 100. The length L7 of the sixth radiation element 260 can be from 1 mm and 5 mm. There is a first distance D1 between the feeding radiation element 120 and the narrower portion 144 of the grounding radiation element 140, and a second distance D2 between the feeding radiation element 120 and the wider portion 145 of the grounding radiation element 140, wherein the second distance D2 can be from 0.1 mm to 3 mm, and the first distance D1 can be at least twice the second distance D2 (i.e., D1≥2·D2). There is a third distance D3 between the fifth radiation element 250 and the connection radiation element 130, wherein the third distance D3 can be greater than or equal to 0.2 mm. There is a fourth distance D4 between the sixth radiation element 260 and the main portion 154 of the shorting radiation element 150, wherein the fourth distance D4 can be greater than or equal to 0.2 mm. The width of the first coupling gap GC1 can be less than or equal to 3 mm. The width of the second coupling gap GC2 can be less than or equal to 3 mm. The width of the third coupling gap GC3 can be less than or equal to 3 mm. The above size ranges are derived from multiple experimental results and assist in optimizing the operational bandwidth and impedance matching of the antenna structure 100 and its and compatibility in different operating modes of the convertible notebook computer.

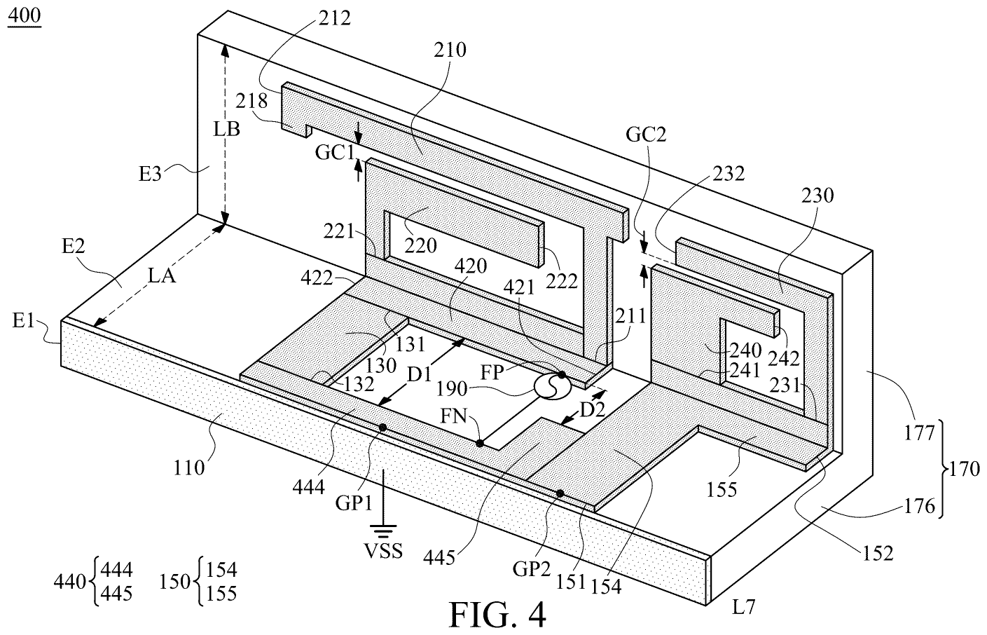

FIG. 4 shows a perspective view of the antenna structure 400 according to another embodiment of the present disclosure. FIG. 4 is similar to FIG. 1. In the embodiment of FIG. 4, the antenna structure 400 does not include the aforementioned fifth radiation element and sixth radiation element, and the feeding radiation element 420 of the antenna structure 400 has a first end 421 and a second end 422, but does not include the aforementioned terminal extension segment. Additionally, the grounding radiation element 440 of the antenna structure 400 includes a narrower portion 444 and a wider portion 445, wherein the negative feeding point FN is located on the narrower portion 444 of the grounding radiation element 440. It should be understood that the aforementioned fifth radiation element, sixth radiation element, and terminal extension segment are optional components, and the position of the negative feeding point FN can be adjusted according to different requirements. The remaining features of the antenna structure 400 in FIG. 4 are similar to those of the antenna structure 100 in FIG. 1, so these two embodiments can achieve similar operational effects.

The present disclosure proposes a novel antenna structure. Compared to traditional designs, the present disclosure has at least the advantages of small size, wideband, high communication quality, and adaptability to different operating modes, making it very suitable for applications on various types of mobile communication devices.

It is worth noting that the aforementioned component sizes, component shapes, and frequency ranges are not limiting conditions of the present disclosure. Antenna designers can adjust these settings according to different requirements. The antenna structure of the present disclosure is not limited to the conditions illustrated in FIGS. 1-4. The present disclosure can include any one or more features of any one or more embodiments illustrated in FIGS. 1-4. In other words, not all illustrated features need to be implemented simultaneously in the antenna structure of the present disclosure.

In the specification and claims, ordinal numbers such as “first,” “second,” “third,” etc., do not imply any order of precedence but are used to distinguish different elements with the same name.

Although the above discloses the preferred embodiments of the present disclosure, it is not intended to limit the scope of the present disclosure. Any person skilled in the art can conduct some modifications and refinements without departing from the spirit and scope of the present disclosure. Therefore, the protection scope of the present disclosure should be defined by the claims below.

What is claimed is:

1. An antenna structure, comprising:
a ground element;
a feeding radiation element, having a positive feeding point;
a first radiation element, coupled to the feeding radiation element;
a second radiation element, coupled to the feeding radiation element,
wherein the second radiation element is at least partially surrounded by the first radiation element;
a connection radiation element;
a grounding radiation element, having a negative feeding point, and coupled to the ground element, wherein the grounding radiation element is further coupled to the feeding radiation element through the connection radiation element;
a shorting radiation element, coupled to the ground element;
a third radiation element, coupled to the shorting radiation element;
a fourth radiation element, coupled to the shorting radiation element,
wherein the fourth radiation element is at least partially surrounded by the third radiation element; and
a nonconductive support element, wherein the ground element, the feeding radiation element, the connection radiation element, the grounding radiation element, the shorting radiation element, the first radiation element, the second radiation element, the third radiation element, and the fourth radiation element are distributed over the nonconductive support element.

2. The antenna structure according to claim 1, further comprising:
a fifth radiation element, coupled to the ground element, wherein the fifth radiation element is in proximity to the first radiation element; and
a sixth radiation element, coupled to the ground element.

3. The antenna structure according to claim 2, wherein the nonconductive support element comprises a first portion and a second portion, and an angle is formed between the second portion and the first portion.

4. The antenna structure according to claim 3, wherein the ground element, the connection radiation element, the grounding radiation element, and the sixth radiation element are disposed on the first portion of the nonconductive support element.

5. The antenna structure according to claim 3, wherein the first radiation element, the second radiation element, the third radiation element, and the fourth radiation element are disposed on the second portion of the nonconductive support element.

6. The antenna structure according to claim 3, wherein the feeding radiation element, the shorting radiation element, and the fifth radiation element extend from the first portion onto the second portion of the nonconductive support element.

7. The antenna structure according to claim 3, wherein a length of each of the first portion and the second portion of the nonconductive support element is greater than or equal to 3 mm.

8. The antenna structure according to claim 1, wherein the grounding radiation element is coupled to a first grounding point on the ground element and comprises a narrower portion and a wider portion, the connection radiation element is coupled to the narrower portion, and the negative feeding point is positioned on either the narrower portion or the wider portion.

9. The antenna structure according to claim 8, wherein, there is a first distance between the feeding radiation element and the narrower portion of the grounding radiation element, and there is a second distance between the feeding radiation element and the wider portion of the grounding radiation element, with the first distance being at least twice the second distance.

10. The antenna structure according to claim 2, wherein the shorting radiation element comprises a main portion and an additional portion, the fourth radiation element being coupled to a second grounding point on the ground element through the main portion, and the third radiation element is coupled to the additional portion.

11. The antenna structure according to claim 1, wherein a first coupling gap is formed between the second radiation element and the first radiation element, a second coupling gap is formed between the fourth radiation element and the third radiation element, and a width of each of the first coupling gap and the second coupling gap is less than or equal to 3 mm.

12. The antenna structure according to claim 2, wherein the first radiation element further comprises a terminal bending portion, a third coupling gap is formed between the fifth radiation element and the terminal bending portion, and a width of the third coupling gap is less than or equal to 3 mm.

13. The antenna structure according to claim 10, wherein the antenna structure covers a first frequency band, a second frequency band, and a third frequency band, the first frequency band is from 2400 MHz to 2500 MHZ, the second frequency band is from 5150 MHz to 5850 MHz, and the third frequency band is from 5925 MHz to 7125 MHz.

14. The antenna structure according to claim 13, wherein a total length of the feeding radiation element, the connection radiation element, and the grounding radiation element is substantially equal to 0.25 wavelength of a central frequency of the first frequency band.

15. The antenna structure according to claim 13, wherein a length of the first radiation element is substantially equal to 0.25 wavelength of the highest frequency of the first frequency band.

16. The antenna structure according to claim 13, wherein a total length of the feeding radiation element and the second radiation element is from 0.16 to 0.25 wavelength of the lowest frequency of the first frequency band.

17. The antenna structure according to claim 13, wherein a total length of the shorting radiation element and the third radiation element is from 0.125 to 0.25 wavelength of a central frequency of the second frequency band.

18. The antenna structure according to claim 13, wherein a total length of the main portion of the shorting radiation element and the fourth radiation element is from 0.125 to 0.25 wavelength of a central frequency of the third frequency band.

19. The antenna structure according to claim 13, wherein a length of the fifth radiation element is from 0.0625 to 0.25 wavelength of a central frequency of the first frequency band.

20. The antenna structure according to claim 2, wherein a length of the sixth radiation element is from 1 mm to 5 mm.
